(19) United States
(12) Patent Application Publication
(10) Pub. No.: US 2016/0342569 A1
(43) Pub. Date: Nov. 24, 2016

(54) METHOD FOR DESIGNING TRANSFORMS FOR SPARSE DATA REPRESENTATION USING ACTIVE REGIONS

(71) Applicant: Hasan Mohammed Ahmed Abdulrahim AL MARZOUQI, Al Ain (AE)

(72) Inventor: Hasan Mohammed Ahmed Abdulrahim AL MARZOUQI, Al Ain (AE)

(21) Appl. No.: 14/714,697

(22) Filed: May 18, 2015

(51) Int. Cl. G06F 17/14

(52) U.S. Cl. CPC G06F 17/14; G06F 17/141

(57) ABSTRACT

Disclosed is a computer-implemented method for representing and analyzing a material having associated therewith spatial domain material-related data. The method converts the spatial domain data into frequency domain using a frequency transform function for generating frequency domain signals having frequency and magnitude composites. After converting, the method selects active regions based on a pre-defined threshold, the active regions being defined by the frequency domain signals having magnitudes above the pre-defined threshold. Further, the method generates active region coefficients by transforming the frequency domain signals related to the active regions into the spatial domain. Thereafter, the method processes the generated coefficients to construct a representation of the material which can comprise constructing an image of the material, determining and illustrating the physical characteristics of the material and/or generating a digital representation of the material and storing and/or transmitting and/or further processing said digital representation, depending on the application.

### FIELD OF THE INVENTION

The present invention relates to sparse data representation, and more particularly to a method and system for the sparse representation of signals using active regions. The invention is particularly relevant for applications such as data denoising, compression, signal acquisition and restoration, seismic data migration, feature extraction, edge detection, and inpainting.

### BACKGROUND OF THE INVENTION

The last two decades have seen tremendous activity in the development of new mathematical and computational tools based on multiscale ideas. Today, multiscale or multiresolution ideas permeate many fields of contemporary science and technology. The development of wavelets and related ideas led to convenient tools to navigate through large datasets, to transmit compressed data rapidly, to remove noise from signals and images, and to identify crucial transient features in such datasets. In the field of scientific computing, wavelets and related multiscale methods can allow for the speeding up of fundamental scientific computations such as in the numerical evaluation of the solution of partial differential equations. By now, multiscale thinking is associated with an impressive and ever increasing list of success stories.

For example, Curvelets were used in the acquisition of seismic data. Wavelets, Contourlets, and Curvelets were proposed for use in data denoising. Algorithms for seismic multiple reduction using wavelets and curvelets were recently proposed. Seismic Migration using wavelets and other wavelet-like transforms is reported to decrease computational time by a significant margin. Adaptive curvelets were proposed as interpretation tools automating classification procedures.

Despite considerable success, intense research in the last few years has shown that classical multiresolution ideas are far from being universally effective. Indeed, just as it was recognized that Fourier methods were not fit for all purposes and consequently new systems such as wavelets were introduced, alternatives to wavelet analysis have been sought. One incentive for seeking an alternative to wavelet analysis is the fact that interesting phenomena occur along curves or sheets, e.g., edges in a two-dimensional image. Curvelets, Contourlets, and other anisotropic transforms are examples of wavelet-like transforms that can better handle such phenomena.

The aforementioned wavelet and wavelet-like transforms work by dividing the frequency content of signals and images into unique frequency bands. This is followed by generating coefficients representative of each frequency band in the spatial domain. The success of these transforms relies on the fact that most signals are sparse (i.e. compact) in the frequency domain. Thus, coefficients representing the signal using such transforms provide a sparse representation of the signal of interest.

The division of frequency content into different frequency bands is regularly performed without regard to signal activity. The frequency content of signals is not used in guiding the divisions of frequency content into unique frequency bands. Important improvements to the sparsity of the generated coefficients are ignored by not customizing frequency domain divisions. Separation of frequency domain contents onto active-regions and non-active regions provide valuable performance improvements in a variety of applications. The present invention develops the concept of “active-regions” and uses it to find improved representations for signals and images. The developed representation is found to be higher in sparsity and yields improvements over previous transform representations.

### SUMMARY OF THE INVENTION

In view of the foregoing disadvantages inherent in the prior-art and the needs as mentioned above, the general purpose of the present disclosure is to provide a computer implemented method for processing of data that is configured to include all advantages of the prior art and to overcome the drawbacks inherent in the prior art offering some added advantages. In nutshell, wavelet and wavelet-like representations described above require a system or method which is capable of overcoming the problem of prior art of not customizing frequency divisions to signal content. The present invention provides a system and method that provides better representation of signals and images by separating non-active from active areas in the frequency plane. Thus, it provides an improved tiling of the frequency plane.

To achieve the above objectives and to fulfill the identified needs, in one aspect, the present disclosure provides a computer-implemented method for analyzing a material having associated therewith spatial domain material-related data. The computer-implemented method is adapted to convert the spatial domain data into frequency domain using a frequency transform function for generating frequency domain signals having frequency and magnitude composites. After converting, the computer-implemented method is adapted to select active regions based on a pre-defined threshold, the active regions being defined by regions in the frequency domain of signals having magnitudes above the pre-defined threshold. Further, the computer-implemented method is adapted to generate active region coefficients by transforming the frequency domain signals of active regions into the spatial domain. Thereafter, the computer-implemented method is adapted to process the generated coefficients in various applications for constructing a representation of the material. The construction of a representation of the material can comprise constructing an image of the material, determining the characteristics of the material or constructing, storing and/or transmitting a digital representation of the material. The invention is particularly relevant for applications such as data denoising, compression, remote sensing, signal acquisition and restoration, seismic data migration, feature extraction, edge detection, and inpainting.

According to one aspect the invention resides in a computer-implemented method for analyzing a material having associated therewith spatial domain material-related data, the method comprising: converting the spatial domain data into a frequency domain representation using a frequency transform function for generating frequency domain signals, the frequency domain signals having phase and magnitude composites; selecting active regions based on a pre-defined threshold, the active regions being defined by the frequency domain signals having magnitudes above the pre-defined threshold; generating active region coefficients by transforming the frequency domain signals related to the active regions into the spatial domain; and processing the generated coefficients in various applications.

Preferably, the frequency transform function is a Fourier Transform (FT) or Discrete Cosine Transform (DCT).

Preferably, the input data is a signal, an audio, a video and/or an image.

Preferably, the spatial domain data is seismic data, medical data and/or remote sensing data.

Preferably, the developed method uses a predefined threshold that is set to represent a magnitude minimum threshold calculated on the basis of the nature of the material. There can be multiple thresholds, as described below.

The determination of the magnitude minimum threshold can be made equal to the median magnitude of the frequency domain signals.

Active regions can be selected by allocating predefined geometrical shapes to regions with significant signal activity in the frequency domain, each of the predefined geometrical shapes being associated respectively with an inverse frequency transform function for generating the active region coefficients.

Active region coefficients can be generated by determining, for each active region, a suitable inverse frequency transform function based on the specific shape of said active region, and using the selected suitable inverse frequency transform for generating the active region coefficients for that associated active region. Therefore, at the outcome, the coefficients related to the active regions can be generated using different inverse frequency transform functions, based on the respective shapes of the active regions.

The predefined geometrical shapes can be a rectangle, circle, parallelogram and/or a random shape for which the associated inverse frequency transform can respectively be an inverse Fourier transform, inverse polar Fourier transforms, inverse Fourier transform using wrapping approach and inverse Fourier transform.

In an embodiment of the invention, the method further comprises determining non-active regions by excluding the frequency domain signals related to the active regions from the generated frequency domain signals, and transforming the frequency domain signals related to the non-active regions into the spatial domain for generating non-active region coefficients, wherein these coefficients are used in various applications.

The determination of non-active regions can comprise determining non-active regions for transformation into spatial domain having allocated therewith predefined geometrical shapes, the predefined geometrical shapes being associated respectively with inverse frequency transform functions for generating the non-active region coefficients.

Non-active region coefficients can be generated by determining, for each non-active region, a suitable inverse frequency transform function based on the specific shape of said non-active region, and using the selected suitable inverse frequency transform for generating the non-active region coefficients for that associated non-active region. Therefore, at the outcome, the coefficients related to the non-active regions can be generated using different inverse frequency transform functions, based on the respective shapes of the non-active regions.

In an embodiment of the invention, the allocation of predefined geometrical shapes to the active and non-active regions is based on the nature/characteristic of the material according to empirical studies.

In an embodiment of the invention, the characteristic of the material is determined from the image of the material.

In an embodiment of the invention, the generated coefficients are used for determining the characteristics of the material in various applications such as image denoising, data migration, data compression, feature detection, and data acquisition and the like.

In an embodiment of the invention, the method can further comprise applying a smoothing function to the generated coefficients to remove boundary artifacts. The Smoothing function is preferably applied to active regions before applying the inverse Fourier transform function to said active regions as described above.

Further, the present invention provides a method for data processing, more specifically to the processing of data related to various applications. The method involves applying of algorithms on data for representing the data in frequency domain using the Fourier transform mechanism. Further, the invention includes applying a reverse mechanism to represent the data in spatial domain. The method is adapted to dividing frequency content of signals or images into different frequency bands depending upon the signal content. The method includes a transform that provides better representation of audio, images, and video content by separating active regions from non-active regions or by discarding non-active regions.

This together with the other aspects of the present invention along with the various features of novelty that characterized the present disclosure is pointed out with particularity in claims annexed hereto and forms a part of the present invention. For better understanding of the present disclosure, its operating advantages, and the specified objective attained by its uses, reference should be made to the accompanying descriptive matter in which there are illustrated exemplary embodiments of the present invention.

### BRIEF DESCRIPTION OF THE DRAWINGS

The advantages and features of the present disclosure will become better understood with reference to the following detailed description and claims taken in conjunction with the accompanying drawing, in which:

FIG. 1 illustrates a flow chart of various steps for the generating coefficients for applying in various application for determining characteristics of the material of the present invention, according to various embodiments of the present invention;

FIG. 2 illustrates a conversion of spatial data (image) into frequency domain, according to various embodiments of the present invention;

FIG. 3 illustrates the active and non-active regions in frequency domain, according to various embodiments of the present invention;

FIG. 4 is an illustration of periodic extension performed to reduce boundary artifacts, according to various embodiments of the present invention;

FIG. 5a illustrates the various shapes of active and non-active regions, according to various embodiments of the present invention;

FIG. 5b illustrates a random-shaped region inside a bounding rectangle, according to various embodiments of the present invention;

FIGS. 6(a) and 6(b) illustrates the operation of a sample smoothing function;

FIGS. 7-10 illustrate various uses of generated coefficients, according to various embodiments of the present invention.

Like numerals refer to like elements throughout the present disclosure.

### DETAILED DESCRIPTION OF THE INVENTION

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

The terms “a” and “an” herein do not denote a limitation of quantity, but rather denote the presence of at least one of the referenced item.

The terms “having”, “comprising”, “including”, and variations thereof signify the presence of a component.

The term “Image Denoising” referred here is a method to achieve both noise reduction and feature preservation of the input image.

The term “Seismic Migration” referred herein is the method by which seismic events are geometrically re-located in either space or time to the location where the event occurred in the subsurface rather than the location that it was recorded at the surface, thereby creating a more accurate image of the subsurface. This process is necessary to overcome the limitations of geophysical methods imposed by areas of complex geology, such as: faults, salt bodies, folding, etc.

The term “Data Compression” referred herein is a method of reducing the size of a data file. In the context of data transmission, it is called source coding (encoding done at the source of the data before it is stored or transmitted) in opposition to channel coding.

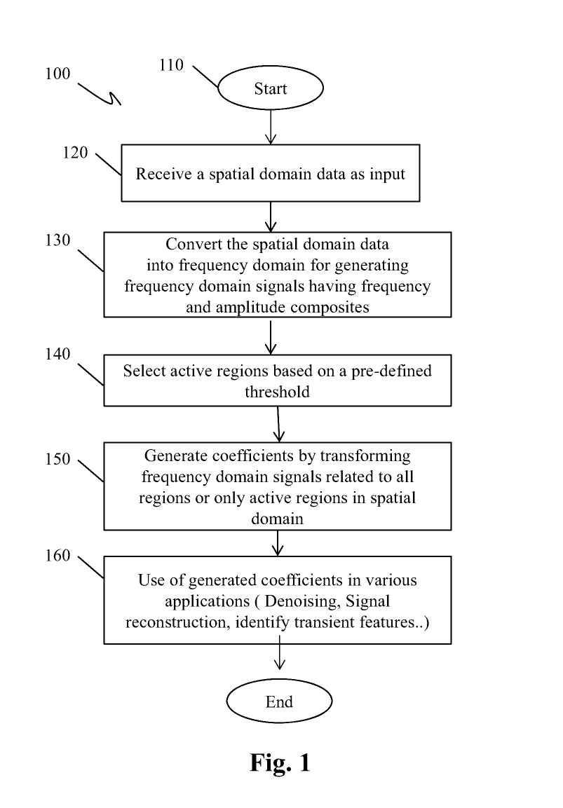

The present invention provides a computer-implemented method for analyzing a material having associated therewith spatial domain material-related data. The computer-implemented method and its usage are described with reference to FIGS. 1-10. The method for generating coefficients which can be used in various applications for better representation of data is shown with reference to various FIGS. 1-3.

One embodiment of the present invention provides a computer implemented method for data processing. The method involves applying algorithms on data to represent data in the frequency domain using the transform functions such as Fourier transform. Further, the invention includes applying a reverse mechanism to represent the data in spatial domain. The method is adapted to dividing frequency content of signals or images into different frequency bands depending upon the signal content. The method includes a transform that provides better representation of audio, images, and video content by separating the frequency plane into active and non-active regions and by ignoring the non-active regions of the frequency plane.

The method will now be explained in detail in conjunction with Figures. Referring to FIG. 1, there is shown a method 100 for the computer implemented method of the present invention. The method 100 starts at step 110. At step 120, the method receives an input data. Without loss of generality, we will describe the invention using a sample image. Input images are normally generated, viewed and operated on in the spatial domain. Images display a matrix of color or gray scale intensities in a 2D spatial plane. They represent a discrete sampling of the change in intensity of a signal in space and there is direct correspondence between the coordinates in the image and space in the “real world”.

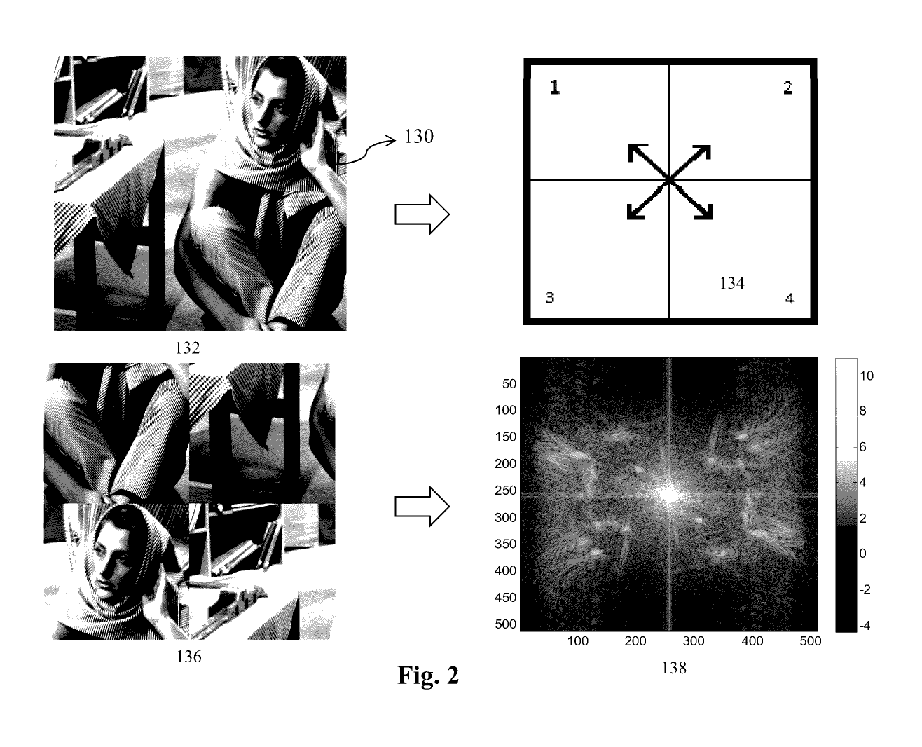

In an exemplary example, as shown in FIG. 2, an image 132 is taken and the image is divided into quadrants as in 134. Thereafter, the quadrants are swapped as shown in 136. Once the swapping of quadrants is performed, the 2D Fourier transform is applied to the already swapped image 136. The formula for the Fourier transform is as below:

$$F ( k , l ) = {\sum }_{n = 0}^{N - 1} {\sum }_{m = 0}^{M - 1} f ( i , j ) {e}^{- i2π ( \frac{kn}{N} + \frac{lm}{M} )}$$

where N and M are the horizontal and vertical image dimensions. This step generates a set of coefficients representing the Fourier plan of the input data. A log-magnitude of the Fourier plane of our sample image is shown 138 of FIG. 2.

Additionally, after the generation of the frequency plane, swapping of the first quadrant of the frequency plane with the third and the second quadrant with the fourth is done. For 1D signals, swapping of the left and right halves of frequency coefficients vector is done. For 3D signals, swapping of the two half-spaces along each dimension is done.

The preceding steps represent the signal in the frequency domain and move the zero frequency components to the centre of the array.

The processing of data represented in frequency domain provides an opportunity for developing sparse representations of signals and images. More generally, frequency domain refers to analysis of mathematical functions or signals with respect to their frequency content, rather than space or time indices.

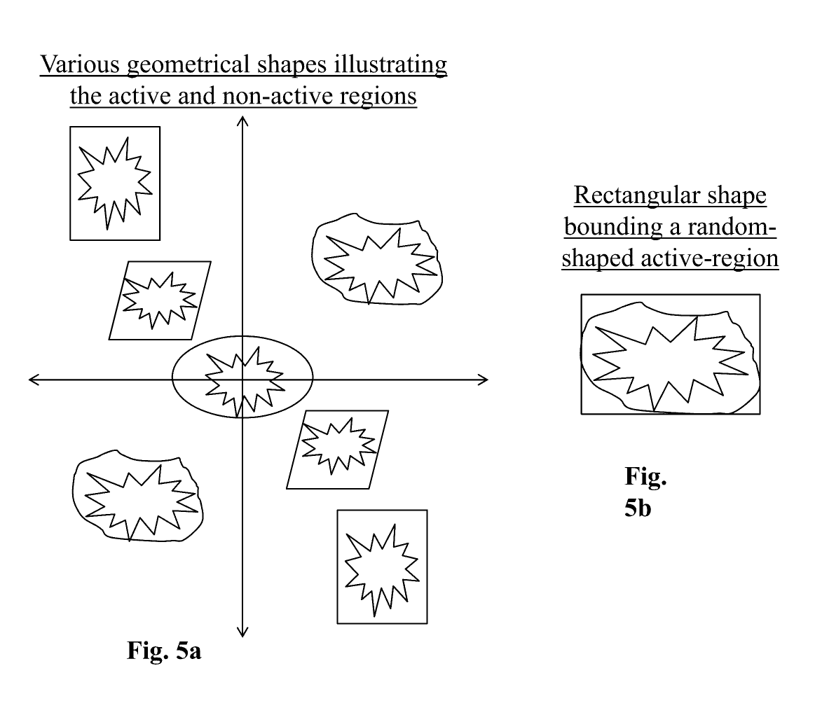

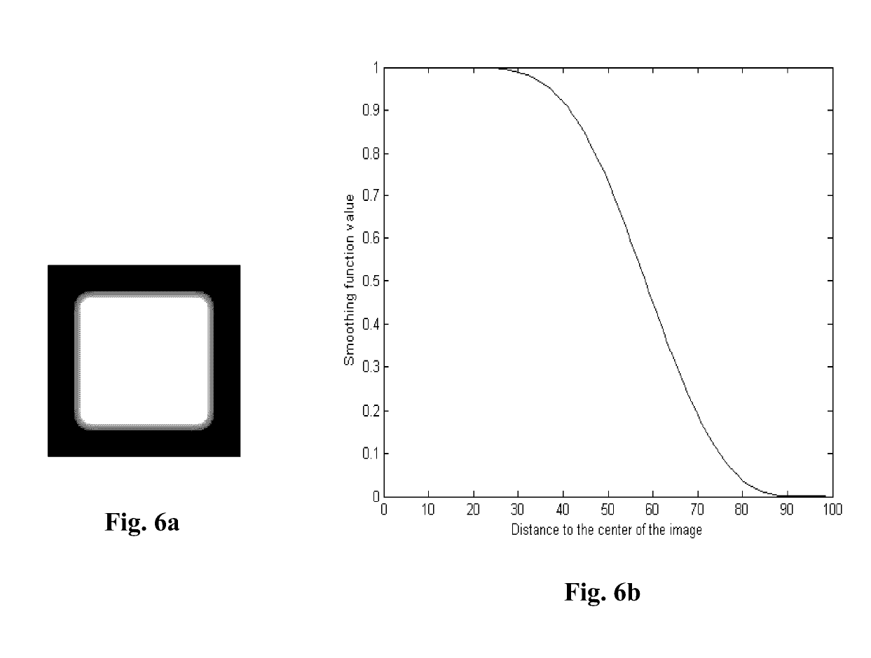

Now at step 130 of FIG. 1, a process for localizing or selecting the active regions is performed. Active regions are regions in the frequency plane in which a significant level of signal activity occurs. Active regions can be rectangular, circular, parallelogram shaped, random shaped, or a combination of these. FIG. 5a shows these shapes on a sample frequency plane.

In an embodiment of the present invention, active regions are determined manually or automatically using image segmentation algorithms. Such algorithms use a threshold value to set the level of activity needed for a region to be labelled active. A threshold value is defined in order to designate a region of the frequency plane as “active”. The threshold value may be in terms of the magnitude of frequency coefficients or a different parameter.

In another embodiment of the present invention, a threshold is defined as minimum size of the shapes identifying the regions. Such threshold is used to designate a region to be considered as active. This second threshold is to be used in conjunction with the magnitude threshold mentioned above, the first threshold determines the magnitude needed and the second threshold determines the size of the regions needed.

A third threshold can be used to set a limit on the maximum size of an active region. When an active region is found to be larger than this third threshold, it is subdivided into two smaller active regions. The divisions can be guided by a cost function that maximizes the total uniformity of frequency (such as Fourier) magnitudes in each subdivision. Minimizing Entropy and minimizing the divergence of frequency magnitudes in the two newly formed subdivisions are two possible cost functions.

Once active regions are identified, the method 100 of FIG. 1 moves to step 150 to generate coefficients representing the given image. Generating coefficients comprises applying transformation functions to transform data from the frequency domain into the spatial domain. Various types of frequency transformation functions are used to transform signals in the frequency domain having specific shapes like rectangles, circles and parallelogram back to the spatial domain. For each shape constructed during the selection of the active regions, a suitable transformation function is chosen to convert the active region back to the spatial domain.

Different types of procedures are used to represent active regions in spatial domain depending upon the shape of the active regions:
i) Rectangular shape regions: These regions are represented in the spatial domain by using the inverse Fourier transform. Mathematically, this operation can be described as follows:

$$f ( i , j ) = {\sum }_{n = 0}^{N - 1} {\sum }_{m = 0}^{M - 1} F ( k , l ) {e}^{i2π ( \frac{in}{N} + \frac{jm}{M} )} ,$$

where M and N represent dimensions of each active-region rectangle.
ii) Circular regions: The inverse polar Fourier transforms is used to represent these regions in the spatial domain. The inverse polar transform is computed using the non-equispaced Fourier transform.
iii) Parallelogram-shaped regions: The inverse Fourier transform on these regions is computed using the wrapping approach known in the art, where the periodicity of the Fourier transform is used to re-index parallelogram coefficients into a rectangular region. The inverse Fourier transform is applied to obtain the spatial representation.
iv) Random-shaped region: Each of these regions is placed inside a bounding rectangular region. Coefficients/magnitudes inside the rectangle are set to zero, if they fall outside the random-shaped region. Otherwise, coefficients/magnitudes are kept at their original value. The inverse Fourier transform is used to generate coefficients representing these shapes. A random-shaped region inside a bounding rectangle is shown in the FIG. 5b. The elongated star shaped element indicates a region where Fourier coefficients magnitudes are high. This region is surrounded by a random-shaped element. The random-shaped element is bounded be a rectangular region to facilitate computation of the inverse Fourier transform.

An alternate method for generating coefficients, which we refer to as the non-subsampled approach, changes the size of active regions to the size of the original image. The 2D inverse Fourier transform is applied next to generate coefficients representing the given image. The change in size can be achieved using an upsampling approach that is based on an interpolation algorithm such as nearest neighbor, linear, spline, and cubic interpolation. An alternate approach is to zero-pad the active regions (i.e. surround it with zeros). The non-subsampled approach is desired in applications where stability with respect to shifts is needed. Furthermore, the non-subsampled approach has the potential of generating improvements to the efficiency of the transform in denoising applications.

In an embodiment of the present invention, regions which are not considered active or regions which are below the threshold value as described above are considered non-active. In applications where a user desires an enhanced accuracy of the representation of the material representation (such as the image), identifying non-active regions is important.

In an embodiment of the present invention, the inverse Fourier transform is used to generate coefficients representing the rectangular non-active regions. An automated algorithm can be used to generate a complete tiling of the frequency plane using rectangular non-active regions, given the chosen active regions.

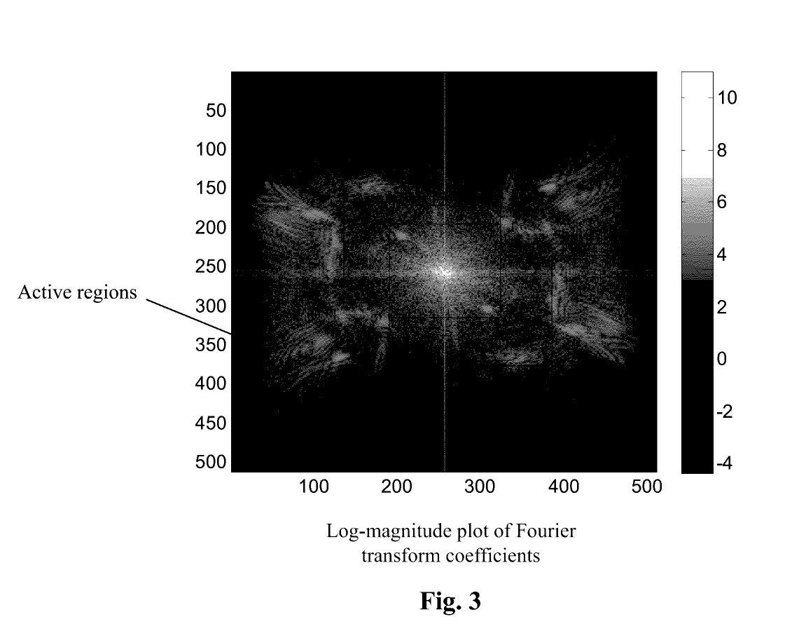

FIG. 3 illustrates an example of allocation of shapes to the active regions in a frequency plane. The rectangles show the active regions. As explained above active regions are regions where significant level of signal activity occurs.

In another embodiment of the present invention, the generated coefficients are used in various manners depending on the application. For example, in most applications such as denoising, edge enhancement, deblurring and migration, mathematical operations on the coefficients are conducted followed by generating an enhanced image of the material. From such accurate and clear image of a material, the characteristics of the material can be determined. In compression and encoding application, operations are conducted on the coefficients followed by storing or transmitting the data.

Reconstructing the input image from the coefficients and distribution of active and non-active regions is performed through steps resembling a reversal of the steps used in FIG. 1. This operation comprise the following steps:
(1) Step 1: taking the Fourier transform of each coefficient set. For rectangle and random shaped regions, the 2D Fourier transform is used, for circular regions the polar Fourier transform, and for the parallelogram-shaped regions the Fourier transform is performed and followed by the tiling approach to re-index the coefficients.
   For the non-subsampled approach: Take the 2D Fourier transform of each coefficient set. If the upsampling approach was performed in the original transform, a downsampling approach is performed to reduce the size of each coefficient set to the original size of active regions. Similarly, removing the added zeros recovers the active regions in the zero-padding approach.
(2) Step 2: placing the Fourier transform of each active region generated in step 1 back into their respective location in the Fourier plane.
(3) Step 3: generating the reconstructed image by taking the inverse Fourier transform of the Fourier plane constructed in step 2.

Optionally, Fourier plane can be extended periodically. The discrete Fourier transform assumes that signal boundaries are connected. Periodic extension can be used as a method to reduce boundary artifacts. This step must be performed before selecting the active regions (140).

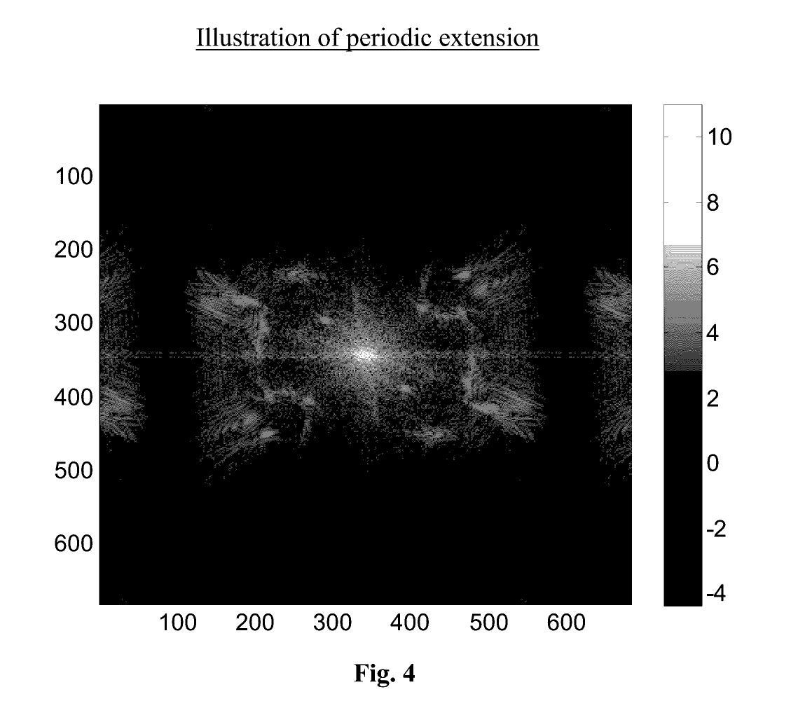

In an embodiment in the present invention, periodic extension is performed by increasing the size of the Fourier plane to 4/3×[M,N] where M and N are the original image dimensions. The new boundary coefficients take the magnitudes of Fourier coefficients in the corresponding coordinates at the other end of the boundary. For example, extension coefficients in the right of the Fourier plane are equal to the Fourier coefficients in the left side of the original Fourier plane. FIG. 4 illustrates the extension procedure applied to the sample image Fourier plane as in 138 of FIG. 2.

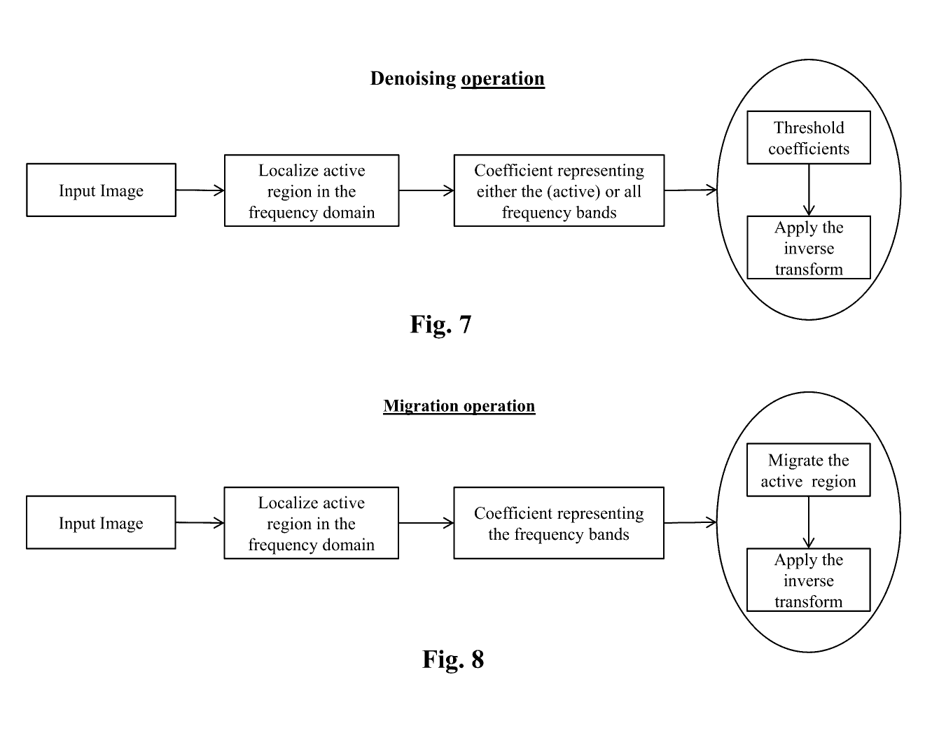

In an embodiment of the present invention, a smoothing function is applied to remove the boundary artifacts of an image. A smoothing function is multiplied by Fourier coefficients that are close to the edge of a tile (active or non-active region). This has the effect of lowering magnitude of coefficients close to the boundary smoothly to zero. An example of smoothing function is shown in FIGS. 6a and 6b. This operation is applied after the selection of active regions (140) and before the generation of coefficients (150) described in FIG. 1.

An example illustrating the operation of smoothing windows is shown in the FIG. 6a. Black color in this figure indicates a function value of zero, while white indicates a function value of one. In this figure, half of the distance between each edge and the center of the square is smoothed. Function values gradually decrease to zero. The smoothing function used is plotted in FIG. 6b.

The generated coefficients and the computed tiling structures are used in various applications. Depending on the nature of the application, a user can opt to use a representation composed of active-region alone, or a representation that includes all the coefficients. The first option increases compactness and can be efficient for applications such as feature detection. The second option provides a more accurate representation to the original signal. It is preferred in applications where the quality of the reconstructed signal is highly valued.

The method as disclosed in the present invention provides an improved and accurate image representation for use in various applications. The method finds it use in various applications like Image Denoising, Seismic Data Migration, Data Compression, Data Acquisition from subsampled measurement and the like.

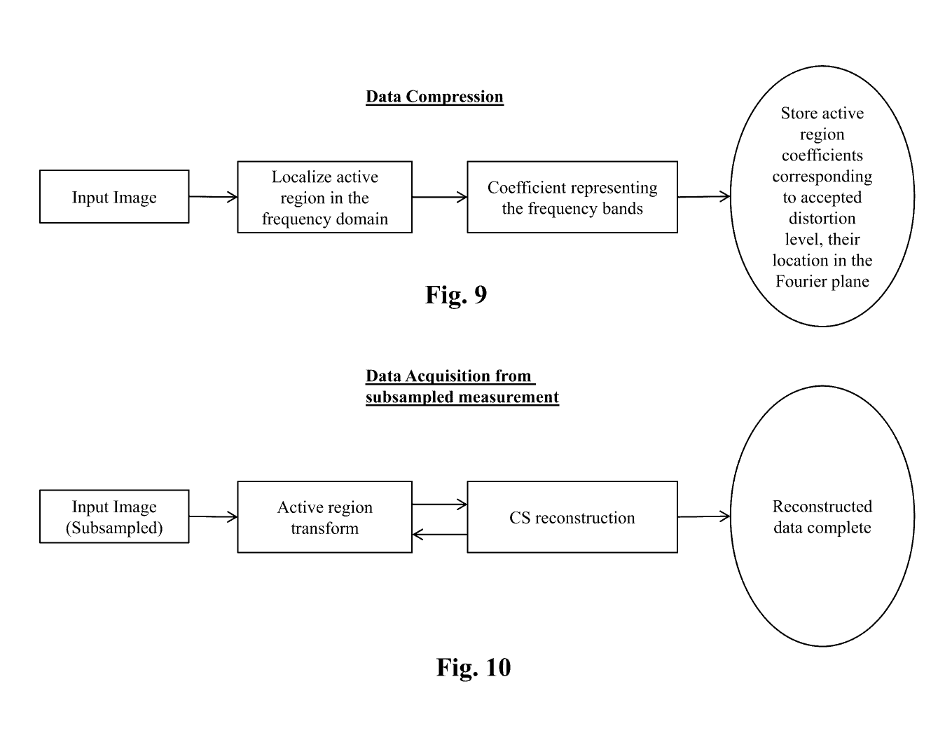

In Image Denoising application, all the coefficients from active and non-active regions are used. Thresholding the coefficients is performed using a method that sets a threshold below which coefficients are set to zero. Next, the inverse transform is applied. The inverse transform reverses the forward active-region based transform operations. FIG. 7 provides a flow of the image denoising method.

Data migration is an important time consuming step in seismic data processing. By working with only active-regions the computational cost of this operation can be reduced. A balance between the level of accuracy needed and the time spent during migration can be introduced by the threshold used in detecting the active regions. A flow diagram of an active-region based migration algorithm is shown in FIG. 8.

The goal of compression operations is to reduce the size of data used. One way by which, the proposed method can be used to achieve this goal is by presenting datasets as coefficients representing the active region parts of the transform. FIG. 9 provides a flow chart for the data compression method involving the proposed invention.

The method disclosed in the present invention finds application in Data Acquisition from subsampled measurement also. Compressed sensing algorithms allow for data reconstruction from a subset of its samples. Such algorithms typically use Fourier, wavelet, and wavelet-like transforms to present the data. Using the active-region based transform in data acquisition is proposed. The location and shapes of active-regions is determined using a learning algorithm that finds the active-regions for a set of complete datasets representing the data to be acquired. FIG. 10 provides a flowchart for the data acquisition procedure involving the proposed method.

As a further aspect of the invention, there is provided computer instructions adapted to execute the method according to the various embodiments of the present invention. The computer instructions are adapted to run on a processing unit or a computer. As another aspect of the invention, there is provided a processing unit, a computer and/or a server running computer instructions adapted to execute the method according to the various embodiments of the present invention. As a further aspect of the invention, there is provided a computer readable medium embedding computer instructions adapted to execute the method according to the various embodiments of the invention.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

1. A computer-implemented method for analyzing a material having associated therewith spatial domain material-related data, the method comprising:
converting the spatial domain data into frequency domain using a frequency transform function for generating frequency domain signals, the frequency domain signals having frequency and magnitude composites;
selecting active regions based on a pre-defined threshold, the active regions being defined by the frequency domain signals having magnitudes above the pre-defined threshold;
generating active region coefficients by transforming the frequency domain signals related to the active regions into the spatial domain; and
constructing a representation of the material using the generated active region coefficients.

2. The method as claimed in claim 1, wherein the frequency transform function is a Fourier Transform Function (FFT) or Discrete Cosine Transform (DCT).

3. The method as claimed in claim 1, wherein the input data is a signal, an audio, a video and an image.

4. The method as claimed in claim 1, wherein the spatial domain data is seismic data.

5. The method as claimed in claim 1, wherein the predefined threshold is a magnitude minimum threshold calculated on the basis of the nature of the material.

6. The method as claimed in claim 5, wherein the determination of the magnitude minimum threshold is made equal to the median magnitude of the frequency domain signals.

7. The method as claimed in claim 1, wherein the selection of active regions comprises allocating predefined geometrical shapes to the active regions associated with respective inverse frequency transform functions for generating the active region coefficients.

8. The method as claimed in claim 7, wherein the generation of active region coefficients comprises, for each one of the active regions:
determining a suitable inverse frequency transform function based on the specific shape of said active region; and
using the determined suitable inverse frequency transform for generating the coefficients related to said active region.

9. The method as claimed in claim 7, wherein the predefined geometrical shapes are a rectangle, circle, parallelogram and a random shape, and wherein the associated inverse frequency transform functions are respectively an inverse Fourier transform, an inverse polar Fourier transform, an inverse Fourier transform using wrapping approach and an inverse Fourier transform.

10. The method as claimed in claim 1 further comprising:
determining non-active regions by excluding the frequency domain signals related to the active regions from the generated frequency domain signals; and
transforming the frequency domain signals related to the non-active regions into the spatial domain for generating non-active region coefficients;
wherein constructing a representation of the material comprises using the generated non-active region coefficients.

11. The method as claimed in claim 10, wherein the selection of non-active regions comprises allocating predefined geometrical shapes to the non-active regions associated with respective inverse frequency transform functions for generating the non-active region coefficients.

12. The method as claimed in claim 11, wherein the generation of non-active region coefficients comprises, for each one of the non-active regions:
determining a suitable inverse frequency transform function based on the specific shape of said non-active region; and
using the determined suitable inverse frequency transform for generating the coefficients related to said non-active region.

13. The method as claimed in claim 12, wherein the predefined geometrical shapes are a rectangle, circle, parallelogram and a random shape, and wherein the associated inverse frequency transform functions are respectively an inverse Fourier transform, an inverse polar Fourier transform, an inverse Fourier transform using wrapping approach and an inverse Fourier transform.

14. The method as claimed in claim 7, wherein the allocation of predefined geometrical shapes to the active regions is based on the nature of the material according to empirical studies.

15. The method as claimed in claim 1 further comprising applying a smoothing function to each active region before generating active-region coefficients.

16. The method of claim 1 wherein constructing a representation of the material comprises constructing an image of the material.

17. The method of claim 1 wherein constructing a representation of the material comprises determining and illustrating the physical characteristics of the material.

18. The method of claim 1 wherein constructing a representation of the material comprises generating and storing a digital representation of the material.

19. A computer running computer instructions adapted to execute the method of claim 1.

20. A computer readable medium embedding computer instructions adapted to execute the method of claim 1.
